(19) United States
(12) Patent Application Publication
(10) Pub. No.: US 2010/0076964 A1
(43) Pub. Date: Mar. 25, 2010

(54) Instance-Class-Attribute Matching Web Page Ranking

(76) Inventor: Daniel Joseph Parrell, Oxford, MI (US)

Correspondence Address: Mr. Daniel J. Parrell, 920 Cross Street, Oxford, MI, 48371, US

(21) Appl. No.: 12/337,181

(22) Filed: Dec. 17, 2008

Related U.S. Application Data
(60) Provisional application No. 61/014,457, filed on Dec. 18, 2007.

(51) Int. Cl. G06F 17/30

(52) U.S. Cl. 707/728; 707/E17.109

(57) ABSTRACT

To be applied on one more data processing systems, a collection of documents is ranked by class and attributes. Each document is associated with at least one primary class. Each class contains at least one attribute which extends the meaning of the class. All documents in the data repository are searched for an instance (keyword). The resulting documents are then grouped by the most frequently found class. Each document within each class is then searched and ordered by the most frequently found attributes for that class. Documents are grouped by most frequently found class and then ordered within each class by most frequently found attribute.

### FIELD OF THE INVENTION

This utility patent defines an algorithm for ranking web pages. It is based on topics and characteristics of a keyword. The premise to having it is to provide more relevant web pages which favor content.

### BACKGROUND OF THE INVENTION

Web search engines currently use a variety of techniques to order and rank the results from the data repository and present the results to the user through a display, printer, or other output media.

This technique provides an alternative way to order and rank web search results based on topics and characteristics typically associated with the keyword being sought.

### SUMMARY OF THE INVENTION

The invention accepts a keyword or multiple keywords as input into the process, searches all occurrences of the keyword in the data repository, groups the results by the most frequently found topics associated with that keyword, and then orders the results within each group by the most frequently found characteristics within the web page which define the keyword.

### BRIEF DESCRIPTION OF THE DRAWINGS

The utility and advantages of it will become better understood with the accompanying figures:

FIG. 1 is a logical flowchart of the process. The three major parts to it consist of “Instance-Class Matching”, “Class-Attribute Matching”, and “Ranking and Output”.

FIG. 2 is a physical flowchart of the process which demonstrates existing specific hardware, software, and component names used to test the utility. Substitute hardware, software, and component names can be used by others who apply this algorithm.

### DETAILED DESCRIPTION OF THE DRAWINGS

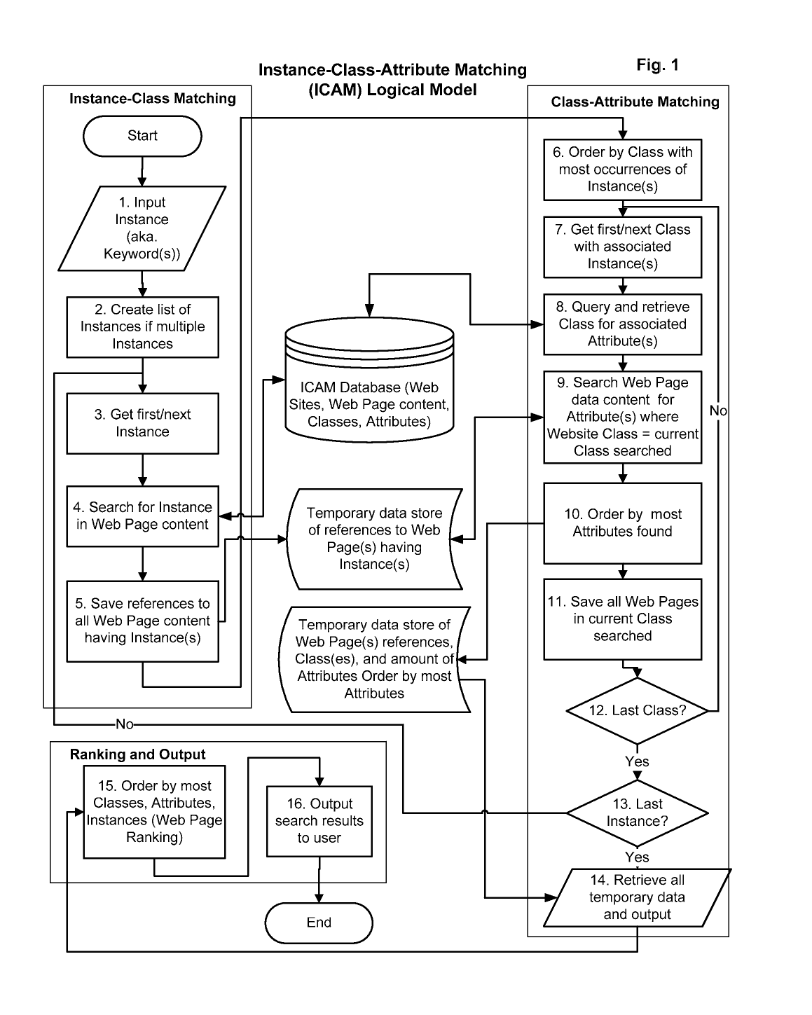

### Logical Model—FIG. 1

The ICAM Logical Model (FIG. 1) consists of a four stage process of:

1. Determining Instances (Steps 1 to 5)—using only keywords from the inputs. Common words (or “noise words”) such as “is, as, the, then” will be removed.

2. Discovering the Instance-Class (Steps 6 and 7)—defining the class and ordering the process by frequency of class found when searching for an instance in a web page.

3. Discovering the Class-Attributes (Steps 8 to 14)—searching the attributes on the web page to see which and how many attributes are located.

4. Outputting the results (Steps 15 to 16)—using the information discovered in the previous steps to output the results for use in a web search and retrieval's page ranking system.

Steps 1 to 5 accept the input and determine if the process will be looped until all instances are evaluated. Inputs for ICAM will be used as instances of a class.

Steps 6 and 7 evaluate all instances to prioritize the associated class by their frequency of occurrence. The process will loop through all classes found that contain an instance located on a web page. This two step process will be used to match the Instance-Class in the ICAM Model.

Steps 8 to 14 evaluate and store all web pages by attributes. These steps will use each class to find all associated attributes for that class and then search through each web page classified under that class for any occurrence of the attribute. If there are more classes the process repeats itself, as per Steps 12 and 13.

Once complete the results are outputted in Step 15 to 16. The second part of the research evaluated the ICAM page ranking, which is defined in the output of Step 16.

### Physical Model—FIG. 1

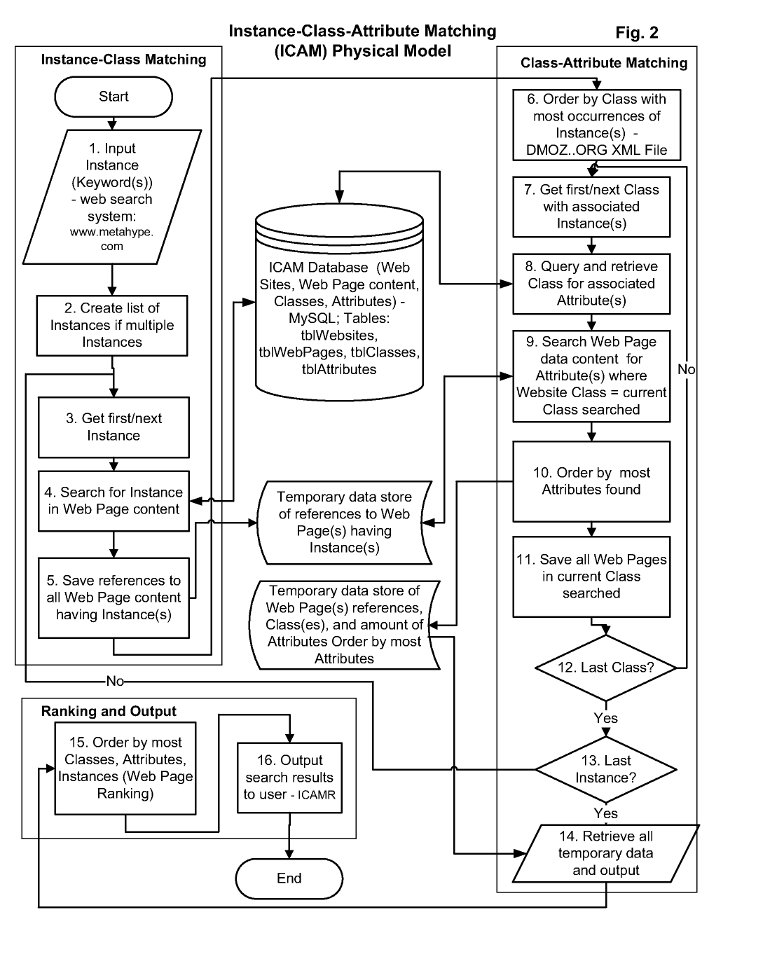

The ICAM Logical Model (FIG. 1) was applied to the Physical Model (FIG. 2) using the same four stage process of:

1. Determining Instances (Steps 1 to 5)—an instance (keyword or phrase) will be parsed from the www.metayhype.com input interface. Common words (or “noise words”) such as “is, as, the, then” will be removed.

2. Discovering the Instance-Class (Steps 6 and 7)—a SELECT query will be executed to find each web page having the keyword. The class will be returned through a Group By COUNT(Class) in Descending Order.

3. Discovering the Class-Attributes (Steps 8 to 14)—a SELECT query will be executed on each web page found in steps 6 and 7 to identify the number of attributes contained in the web page for the class. The link to the web page will be returned through a Group By COUNT(Attribute) in Descending Order.

4. Outputting the results (Steps 15 to 16)—the results will be outputted using the information discovered in the previous steps to the www.metahype.com interface web search and retrieval page ranking system.

In summary, the ICAM database is populated with data before queries could be executed. Tables were built for the sites, classes, and attributes. The Site table contains the Site URL, Class Identifier, and Site Content. The Class table contains the Class Identifier and Class Name. The Attribute table contains the Attribute Identifier, Class Identifier, and Attribute.

### Steps 1 to 5: Determining Instances

This step accepts input into the ICAM process, remove any “noise words” from the input, and search all web pages in the relational database for any occurrence of the input. Input was evaluated in this study as an AND conditional statement where input will be treated as a single instance. Any occurrence of the instance found on any web page will be saved and later processed. Input that is converted into instances for searching through the database can be evaluated as an AND, OR, or XOR (exclusive OR).

### Steps 6 and 7: Discovering the Instance-Class

This step examines the Class-Attribute Matching part of the ICAM model. Database queries were performed for the Class-Attribute Match. Both the Class and the Attributes tables had a primary and secondary key to join each table together. Each web site listed for a class was accessed from stored data in the ICAM relational database retrieved during the ICAM Database Pre-Population Phase. The main web page was retrieved for that web site and the text part of the web page was searched for the attribute(s).

### Steps 8 to 14 Discovering the Class-Attributes

Once the Attribute-Class web site(s) match is determined, the model searches through the text of each web site for the attributes and then logged the results. Each web site under the class was accessed, the data was retrieved, and then a search was conducted within the web page content for the attribute(s).

Step 15 to 16: Outputting the results

Once the instance(s), web site(s), class(s) and attributes(s) are matched the data is outputted. This is a powerful process that identifies which web site(s) contain common information found for the instance(s) searched.

1. A web page ranking algorithm consisting of: input in the form of a keyword(s) which searches through a corpus of data and then matches all occurrences of the keyword(s).

2. The combination defined in claim 1, wherein the assignment of the web page-to-class will depend on the content within the web page.

3. The combination defined in claim 1, wherein attributes of a class can be manually created or automatically created.

4. The result is grouped by the most frequently found class.

5. The combination defined in claim 4, wherein classes can be manually created by humans or automatically created by a system or process.

6. The combination defined in claim 4, wherein web pages can be manually assigned to a class or automatically assigned to a class.

7. The combination defined in claim 4, wherein all documents are assigned to at least one class.

9. The combination defined in claim 4, wherein a class can have one or more attributes.

10. The class grouping is then ordered by the most frequently found attributes which defines the class.

11. The combination defined in claim 10, wherein all classes contain at least one attribute which extends the definition of the class.

12. The combination defined in claim 10, wherein attributes can contain one or more words.
